(19) United States
(12) Patent Application Publication
(10) Pub. No.: US 2026/0331449 A1
(43) Pub. Date: Oct. 22, 2026

(54) METHOD AND APPARATUS FOR MONITORING AND CONTROLLING THE PERFORMANCE OF AN ION SOURCE

(71) Applicant: Bruker Daltonics GmbH & Co. KG, Bremen (DE)

(72) Inventors: Karl-Otto KRÄUTER, Bremen (DE); Thomas MAIER, Bremen (DE); Sven BRAND, Bremen (DE)

(21) Appl. No.: 19/107,675

(22) PCT Filed: Aug. 24, 2023
(86) PCT No.: PCT/DE2023/100616

§ 371 Date: Feb. 28, 2025

(30) Foreign Application Priority Data
Sep. 15, 2022 (DE) 10 2022 123 559.9

(51) Int. Cl. H01J 49/16; H01J 49/00

(52) U.S. Cl. CPC H01J 49/164; H01J 49/0031

(57) ABSTRACT

The invention relates to a method and to an apparatus for monitoring and controlling the performance of an ion source, comprising: (a) laser-assisted ionization of a control sample, the composition of which is substantially known, and which is sampled before, parallel to or after an analytical sample, (b) generating spectral control sample data from the ionized control sample in an ion analyser connected to the ion source, (c) repeating steps (a) and (b) over a multitude of control samples in order to collect a multitude of spectral control sample data and evaluate them such that spectral data of individual control samples have low weight and a performance trend appears in the evaluation, (d) adjusting an operating parameter of the laser of the ion source if the performance trend enters a range outside a predefined performance interval, in order to bring the laser into interval conformance, and (e) repeating steps (a) through (d) for continuous monitoring and control of the ion source.

### FIELD OF THE INVENTION

The invention relates to monitoring and control of the performance of an ion source that works with laser-assisted ionization, in particular with MALDI ionization. The invention specifically relates to an ion spectrometry system having an ion analyser, an ion source connected to the ion analyser, and a processor unit that communicates with the ion analyser and ion source.

### BACKGROUND OF THE INVENTION

The prior art is elucidated hereinafter with reference to one specific aspect. However, this should not be understood to be a restriction. Useful advances and alterations from what is known from the prior art may also be applicable beyond the comparatively narrow scope of this introduction and will be immediately apparent to trained practitioners in this field after reading the disclosure of the invention that follows this introduction.

In MALDI time-of-flight mass analysis (MALDI, matrix-assisted laser desorption and ionisation), there are some operating parameters that are important for a usable measurement. These operating parameters include the spectral baseline, various electrical voltages between acceleration electrodes for the flight path, the detector voltage and the laser energy density of the ion source, to name just a few. These parameters are typically tested either at the test facility of the mass spectrometer manufacturer or in the user's laboratory by qualified service personnel from the manufacturer or a contractor, and set for the best possible results. However, these measures are isolated events, and so the mass spectrometer after setup or readjustment has to function unmonitored over a long period of time.

However, it is known and accords with experience that some parameters vary over the operating time and use time of the mass spectrometer. This can also be referred to as ageing or wear. Among the aforementioned parameters, in particular, detector voltage is affected directly and laser energy density indirectly.

A particular manifestation of detector ageing is that the amplification factor, for example of a secondary electron multiplier, declines with progressive operation. This drop is typically countered with an increase in detector voltage, i.e. in the voltage gradient over which the secondary electrons are accelerated. This need for adjustment of the detector voltage in practice builds up over quite a long period of time and can be determined in a largely automated manner, for example in calibration phases in which single ion signals are observed, as described in patent publication DE 10 2008 010 118 A1 (corresponding to GB 2 457 559 A and US 2009/0206247 A1).

In the case of laser energy density, it may be the case that the ion source and in particular the surfaces therein, for example of electrodes or boundary housing parts, becomes soiled with advancing operation and hence there is a change in the conditions under which the electrical fields arise in the ion source. This is then manifested in a reduced ion yield. Such a drop in performance can be countered, for example, by semi-automated or fully automated cleaning that at-tempts to eliminate or at least alleviate the perturbation by physicochemical interaction. One example of such a cleaning operation is presented in patent publication DE 10 2008 008 634 A1 (corresponding to GB 2 457 362 A and US 2009/0200457 A1). A further option is to increase the laser energy density or laser fluence, since the ion yield is proportional to a multiple power of energy density or fluence, as elucidated in the review article by Klaus Dreisewerd (Chem. Rev. 2003, 103, 395-425). Depending on utilization of the analyser, thinking of virtually uninterrupted measurement phases daily from early until late, the need for remedy resulting from soiling can build up quite rapidly compared to detector ageing.

As soon as a mass spectrometer is installed for the first time in a user's laboratory, intensive operation can have the effect, for example in the case of identification measurements on disease-causing microorganisms in the clinical sector that are repeated with high throughput, that such drops in performance occur so quickly that maintenance operations are needed with high frequency, for example weekly or even more frequently: a huge imposition for service personnel and simultaneously a cost driver for the user.

Some prior art documents that may be of relevance for the disclosure, without any claim to completeness, are briefly acknowledged hereinafter.

The basis of the technical teaching disclosed in patent publication DE 10 2010 019 857 A1 (corresponding to GB 2 483 322 A and US 2011/0272573 A1) is to record multiple series of mass spectra of a mixture of analyte substances while increasing the energy density stepwise at the laser foci, but at the same time dealing with the problem of signal saturation at the detector that possibly arises via special measures.

Patent publication WO 2014/140625 A1 discloses a method of ion imaging, comprising the testing of a first sample portion by automatic variation of one or more laser parameters, and manual or automatic determination of one or more optimal or preferred laser parameters from the first sample portion. A second sample portion is then analysed using the one or more optimal or preferred parameters.

Patent publication WO 2017/160857 A1 relates to systems and methods for real time monitoring of laboratory analysis devices for the purpose of quality control.

Patent publication EP 3 806 135 A1 describes a MALDI ion source in which laser light from a laser light source is reflected by a mirror, and the laser light energy is adjusted by rotating a polarization beam divider. Then the laser light with adjusted energy is steered onto a sample.

Patent publication EP 3 651 184 A1 relates to a mass spectrometer and to methods and programs for adjustment of laser light intensity that are used in the mass spectrometer for MALDI ionization.

In view of the above elucidations, there is a need to provide methods and apparatuses with which monitoring and control of the performance of an ion source can be assured and im-proved over a prolonged period of time. Further objects to be achieved by the invention will be apparent to the person skilled in the art directly on reading the disclosure that follows.

### SUMMARY OF THE INVENTION

In a first aspect, the present disclosure relates to a method of monitoring and controlling the performance of an ion source, comprising: (a) laser-assisted ionization of a control sample, the composition of which is substantially known, and which is sampled before, parallel to or after an analytical sample, (b) generating spectral control sample data from the ionized control sample in an ion analyser connected to the ion source, (c) repeating steps (a) and (b) over a multitude of control samples in order to collect a multitude of spectral control sample data and evaluate them such that spectral data of individual control samples have low weight and a performance trend appears in the evaluation, (d) adjusting an operating parameter of the laser of the ion source if the performance trend enters a range outside a predefined performance interval, in order to bring the laser into interval conformance, and (e) repeating steps (a) through (d) for continuous monitoring and control of the ion source.

In various embodiments, in step (a), the control sample may be sampled in an identical measurement operation to the analytical sample and, in step (c), steps (a) and (b) may be repeated over a multitude of measurement operations and control samples. A measurement operation in the context of the present disclosure may especially be considered to be that in relation to the mode of operation of the ion spectrometry system. For example, a measurement operation may comprise all measurements that are recorded from (control) samples on a sample carrier while it is spatially within the ion source. One example would be the introduction of the sample carrier into a reduced-pressure region of the ion source while it is working under reduced pressure, for example in the case of vacuum MALDI. If the sample carrier is removed from the ion source, for example the reduced-pressure region, and then a further sample carrier with new (control) samples is introduced again, all measurements on the new (control) samples on this next sample carrier may be regarded as a separate measuring operation.

As well as preparations of analytical samples, it is also possible for multiple control sample preparations to be disposed on a sample carrier for laser-assisted ionization. If there are both control samples and analytical samples on the sample carrier, e.g. 2-10 technical control sample replicates, especially 4-8 technical control sample replicates, all spectral control sample data for these preparations can be used to ascertain the performance trend and/or the progression thereof over time. A control sample preparation on the sample carrier can be sampled once or else more than once to generate spectral control sample data, limited in principle solely by the quantity of the control sample. As a result, the spectral control sample data may comprise individualized and separate spectra. Repeated sampling of the same control sample preparation increases the basis of the spectral control sample data for a subsequent statistical evaluation and reduces the effect of very short-term perturbations in particular in the measurement sequence that can cause outlier measurements.

What may be meant in particular by sampling of the control sample before, parallel to or after an analytical sample is that control sample and analytical sample are examined in the same measurement operation. The control sample may especially be sampled immediately before or immediately after an analytical sample. The measurement modes or measurement settings of the ion spectrometry system may be corresponding or else different for the sampling of analytical samples and control samples. If a measurement operation comprises the recording of spectral data of all (control) samples of a sample carrier, as set out above, this may mean that the sample carrier has a multitude of designated sample sites, for example a field of sample spots as on the known AnchorChip or MBT Biotarget 96 carriers from Bruker or else on a steel plate, and some of these sample sites are firstly prepared with a predetermined number of control samples, whereas some or all of the remaining sample sites are occupied by analytical samples. Control samples and analytical samples can then be sampled in blocks separately from one another (for example first all control samples, then all analytical samples, or vice versa) or else alternately (e.g. control sample⇒analytical sample⇒control sample⇒analytical sample etc.). In ion sources with multiple laser beams, it is optionally also possible to measure analytical samples and control samples in parallel from the same sample carrier if the connected ion analyser is designed and set up for the processing of multiplexed ion currents or when there is more than one ion analyser.

In various embodiments, the ion analyser may be designed as a mass analyser that sorts the ionized control sample in particular by the principle of time-of-flight (TOF) dispersion. A mass analyser separates charged molecules or molecular ions according to their mass-to-charge ratio, typically referred to as m/z. As well as the time-of-flight analysers already mentioned in the introduction, for which both linear and reflector constructions and/or those with axial or orthogonal acceleration of ions onto the flight path may be provided, it is also possible in principle to use other types of mass-dispersing separators, e.g. quadrupole mass filters (single quads), triple quadrupole analysers (triple quads), ion cyclotron resonance (ICR) cells, Kingdon-type analysers such as the Orbitrap® (Thermo Fisher Scientific) and others.

In various embodiments, the ion analyser may also be a mobility analyser or combined mobility/mass analyser. A mobility analyser separates charged molecules or molecular ions according to their collision cross section-to-charge ratio, occasionally referred to as Ω/z or σ/z. The basis for this is the interaction of the ion species with an electrical field that couples to the charge of the ions, under the simultaneous action of a buffer gas that acts on the average cross-sectional area of the ion. In particular, drift tube mobility analysers with a static electrical field gradient are known, which drive ions through an essentially stationary gas, resulting in the drift speed of an ion species from the driving force of the electrical field and the slowing force of the impacts with the gas particles. Likewise familiar are trapped ion mobility separators (TIMS) with a constant laminar gas flow that drives the ions onward, counteracted by an electrical field gradient which is varied stepwise with a correspondingly variable slowing force. Travelling wave mobility separators may also be mentioned. It will be apparent that analysers of the aforementioned types may be coupled in order to be able to separate ion species multidimensionally, i.e. according to more than one physicochemical property such as m/z, Ω/z or σ/z.

In various embodiments, the control sample may comprise processing of a microorganism, for example a prokaryotic organism, especially processing of a bacteria species. Microorganism cells having an exactly known taxon and defined content of soluble molecules, e.g. ribosomal proteins and peptides, can be purchased commercially. Such a configuration in the case of standardized preparation can be expected to give a readily predictable and constant analyser and detector response with regard, for example, to mass signal profile or abundance. One example is the Bacterial Test Standard for the MALDI Biotyper® from Bruker, a MALDI axial-linear time-of-flight mass spectrometry system; the standard comprises a typical Escherichia coli DH5 alpha-peptide and protein profile, and additional proteins, suitable for uses including mass calibration.

The multitude of control samples is preferably congruent or identical; in particular, control samples that are congruent or identical are used over the multitude of measurement operations. In the case of microorganism preparation as a control sample, the measurements can be recorded over many preparations and a long period of time from biological and/or technical replicates of the microorganism.

If the control sample comprises a microorganism, it has preferably been sterilized. The sterilizing may comprise exposure of the microorganism to a metabolism-inhibiting liquid, e.g. an alcohol such as ethanol or isopropanol or an acid such as formic acid, and/or to energy, for example using heat or high-energy radiation (especially ultraviolet light). What is meant in particular by sterilizing is that the microorganism loses the ability to replicate even under conditions that are favourable to it. In this way, the biological risks attendant to unintended/uncontrolled spread can be avoided in an analysis laboratory. Under particular conditions, it may be dispensable to sterilize the microorganism in a control sample, for example when working in an analysis laboratory of biological safety level 2 or higher. It can be assumed in that case that sufficiently trained skilled personnel is being employed.

In various embodiments, the ion source may work by the MALDI principle. The principle of matrix-assisted laser desorption and ionization (MALDI) has already been described in detail elsewhere; see, for example, the article by Klaus Dreisewerd mentioned in the introduction. In a widespread variant of MALDI sample preparation, soluble molecules, e.g. ribosomal proteins of a microorganism or bacterium, are inserted into a structure of matrix crystals that have a high absorption capacity for laser light. Matrix substances chosen are small organic molecules that absorb energy strongly at the laser wavelength used, e.g. solid-state Nd: YAG at a frequency-tripled wavelength of 355 nanometres. Examples of these are sinapic acid, 2,5-dihydroxybenzoic acid, α-cyanohydroxycinnamic acid or 2,4,6-trihydroxyacetophenone. If the matrix crystal structure is exposed to pulses of laser radiation, it evaporates explosively and releases the embedded molecules. In addition, molecules are ionized during this high-energy ablation process. These are thus amenable to a subsequent ion spectrometry analysis. For this analysis, the ions are generally accelerated in electrical fields to different speeds according to their mass and, after passing through a relatively long, largely field-free flight path, arrive at a detector having secondary electron multipliers in a time-resolved manner. The periods of time from the laser desorption of the sample material or from an acceleration pulse onto the flight path of the mass analyser until reception of the different ion current signals at the detector give the charge-based masses m/z of the ions via a conversion.

Example of establishment of a MALDI measurement. In the new establishment of a MALDI test method, some operating parameters are defined ideally with the aid of a standard that has been produced in a controlled manner and contains a very well-defined number and concentration of target molecules in the mass range sought (control sample). This standard, e.g. Bacterial Test Standard from Bruker, is freshly prepared and analysed in the device. Prior to measurement of this standard, it is also possible to separately define other operating parameters, for example a levelling voltage for establishment of a largely field-free space in the desorption region of a MALDI sample carrier (called back bias), the detector voltage or baseline. An important parameter of a MALDI measurement is the laser energy density. If the laser energy density is too low, barely any ions, if any, are generated. If the laser energy density is too high, the ion cloud generated is populated by too many charge carriers and the mass resolution in the connected analyser is unable to cope. It is therefore preferable to find and define what is called a “desorption threshold”. This threshold of laser energy density defines the point where, after increasing the laser energy density stepwise from a low initial value, the first ion signals can be identified using the detector. Proceeding from this desorption threshold, the laser energy density is then preferably increased further for the initial device setting in order to achieve a compromise between signal number and strength and deterioration in mass resolution. Such a preferred laser energy density is typically a few percentage points above the desorption threshold.

The laser energy density for later measurements of analytical samples is adjusted such that it is possible to analyse both samples having low and high analyte concentration. In other words, the laser energy density is varied by a few percentage points during the measurement of analytical samples; for example, it is possible to increase or lower the energy density after the first attempted measurement in order to obtain optimally utilizable signals. If the analyte concentration in the sample is too large, the initial laser power is reduced. If the analyte content of the sample is too low, the laser power is increased. However, it may be a consequence of this procedure in practice that a suboptimally adjusted laser or a soiled ion source remains undiscovered for a long period because the laser energy density can be constantly increased during the measurement, which is a measurement disadvantage, for example, for samples of low analyte content.

According to current practice, a MALDI measurement of analytical samples is therefore capable only to a limited degree of monitoring and readjusting the initially optimized laser energy density since the MALDI measurement itself can be very variable and depend on many parameters. Declining laser power or a soiled ion source are factors that can cause an increase in laser energy density. The invention presented here is based essentially on the frequent measurement of a defined standard or a control sample, the composition of which is substantially known, with a laser energy density fixed for performance monitoring measurement, with the particular aim of finding an expected signal intensity. Since a single MALDI measurement can nevertheless be very variable, these measurements are averaged over a prolonged period of time in order to suppress the effect of short-term or diurnal variances. If the expected signal intensity is not found, a starting laser energy density value for the measurements of analytical samples can be readjusted and serves as a base on which the above-elucidated single measurement-based variation for analytical samples builds.

In various embodiments, the performance trend can be derived from an abundance or intensity of ions detected in the analyser; in particular, it is possible to use an average abundance or intensity. A measure of intensity or of abundance that can be used is, for example, the total amount of ion currents detected in the spectral data; this is occasionally called total ion count (TIC). The TIC can be detected over the entire spectral range or else over a limited sub-range, for example a range from the spectral data of 30 000 or more atomic mass units (amu), 20 000 or more amu, 10 000 or more amu, 5000 or more amu or 1000 amu or more. It is also possible to use an average intensity over the entire spectral range or a section thereof as a basis, for example a range from the spectral data of 30 000 or more atomic mass units (amu), 20 000 or more amu, 10 000 or more amu, 5000 or more amu or 1000 amu or more. A broad data basis assures statistical stability, i.e. low weight for outliers in the case of consideration over several control samples, control sample samplings or measurement operations.

In various embodiments, the performance interval may comprise variances up to a predefined percentage, especially ±30 per cent or less, ±25 per cent or less, ±20 per cent or less, ±15 per cent or less, or ±10 per cent or less, from a performance guide value. If an intensity measure is used for the assessment of performance, it is possible-enabled by substantial knowledge of the molecular content of the control sample-to determine, for example, an intensity guide value which is placed into an interval, the limit of which towards higher intensities results from avoidance of detector saturation and the lower limit of which towards lower intensities is derived from experience as to how high an ion current signal must be to permit a detectable and reliable evaluation of spectral data. The interval limits may be in an equidistant or else non-equidistant arrangement from the performance guide value. In one embodiment, an upper interval limit may lie closer to the performance guide value than a lower interval limit; in another embodiment, a lower interval limit may lie closer to the performance guide value than an upper interval limit.

In alternative embodiments, the performance trend may also be derived from the quality of characterization of the molecular content of the substantially known control sample. If, for example, a microorganism is used as control sample, the highest similarity index [also called log(score)] of the relevant spectral reference data of an ion spectrometry system designed for identification of the taxon, such as the MALDI Biotyper® from Bruker, may serve as performance guide value. Since the taxon of the microorganism in the control sample is substantially known, what is called the log(score) of the MALDI Biotyper® should be well above 2.00. If the effect of the trend is that the log(score) is below the lower interval limit of 2.00 over a prolonged observation period and hence independently of outliers, it may be necessary to adjust an operating parameter of the laser in order to counteract this drop in performance.

In various embodiments, the evaluation in step (c) may subject the multitude of spectral control sample data to averaging, especially mean or median averaging. The average formation may especially be based on the arithmetic average. By the recording of spectral control sample data over a multitude of control samples, control sample samplings or measurement operations, it is possible to form a moving average; in other words, from a set of measurements, a subset that varies over time can be adduced, for example by taking account of spectral control sample data from a moving time window, optionally over a multitude of measurement operations, for average formation.

In various embodiments, the averaging may be applied to a predetermined number of (i) control samples, e.g. 50-250 control samples, (ii) measurement operations, e.g. 10-30 measurement operations, (iii) laser activations, for example over 10⁵-10⁷ laser shots for single spectral data images, or (iv) a number of control samples or measurement operations from a predetermined period of time, for example over a period of 7-21 days, 1-4 weeks or 1-2 months. It is likewise possible to apply the averaging to a predetermined number of individualized control sample samplings, for example 400-2000 individualized control sample samplings. A common factor to all embodiments of the present disclosure is that the need for adjustment of the laser operating parameter is not made dependent on a single control sample and certainly not on an individual control sample sampling, but rather is based on a multitude of control samples and a multitude of control sample samplings.

In various embodiments, for adjustment of the operating parameter, laser energy density, laser fluence, laser power and/or laser intensity in the laser-assisted ionizing operation can be altered. In particular, laser energy density, laser fluence, laser power and/or laser intensity can be increased by a preset percentage if a variance in performance trend is recognized. An increase may be in the range of substantially single-digit percentage values, e.g. 1-10 per cent, especially about 1 per cent. In the case of MALDI ionization, the ion yield is proportional to about the sixth to eighth power of laser fluence, such that an increase therein by 1 per cent entails a rise in detectable ions by about 6-8 per cent. Such a measure may already be sufficient to counteract a negative performance trend and to bring the laser interval into conformance. The adjustment of the operating parameter of the laser may alternatively comprise a predefined increment, e.g. a particular percentage; it may also be calculated depending on the trend progression and/or absolute variance from the interval limit, for example with a fixed increment (optionally a percentage) as a basis, which is corrected by a trend-dependent term in order to avoid oversteer in the adjustment and to make the adjustment routine less dependent on outliers.

In various embodiments, a notification and/or marking may be generated if a number of adjustments of the operating parameter reaches or exceeds a predetermined value, e.g. 2-10 adjustments, especially 3-5 adjustments. The notification may take the form of an entry in the log file of the ion spectrometry system used. Also possible are notifications for the immediate attention of a user, for example a window that opens with a textual or pictorial message in the graphic user interface on the computer of the ion spectrometry system or an automatically generated email or SMS, the contents of which summarize the result of the spectral data evaluation. Such a textual/pictorial message, email or SMS can be transmitted directly to a recipient address of the ion spectrometry system manufacturer or a service partner, in order to automatically issue a maintenance request. A marking may especially include an entry in a comments field of the metadata for the spectral data that have been recorded under the altered laser conditions. In this way, it can be made possible for the user also to track the automated laser readjustment at a later juncture, for example in the evaluation of the spectral data of the analytical samples that have been detected alongside the spectral data of the control samples.

In various embodiments, a composition of the analytical sample may be substantially unknown. Control sample and analytical sample differ in particular in that the control sample, its molecular content and its behaviour during laser-assisted ionization are very well known and characterized, which is the reason why it is used as controlled variable. By contrast, the information about the analytical sample first has to be ascertained by possibly elaborate post-processing from the corresponding spectral data. In the case of MALDI ionization, in the preparation of the analytical sample, only the matrix substance is well known; by contrast, molecular content and ionization behaviour of the analyte molecules are not verified and have to be ascertained. The analytical sample may, for example, be a preparation assumed to contain a microorganism and/or extracted molecules, with the aim of determining the taxon of the microorganism down to the species and/or else resistance behaviour towards an antimicrobial substance. The analytical sample may also be a preparation containing cells, e.g. eukaryotic cells, the behaviour and/or re-action of which to exposure to a particular stimulus is to be examined, for example exposure to a toxicologically and/or pharmacologically active substance.

In a second aspect, the present disclosure relates to an ion spectrometry system having an ion analyser, an ion source connected to the ion analyser, and a processor unit that communicates with the ion analyser and the ion source and is designed and programmed to coordinate and execute a method as elucidated and described above.

### BRIEF DESCRIPTION OF THE FIGURES

For better understanding of the invention, reference is made to the figures that follow.

The elements in the figures are not necessarily shown true to scale, but are intended primarily to illustrate the principles of the invention (schematically for the most part). In the figures, mutually corresponding elements in the different views are identified by the same reference numerals.

FIG. 1 schematically illustrates the principle of an axial-linear time-of-flight mass spectrometry system with laser-assisted ionization; for example the microflex® LT/SH from Bruker.

FIG. 2 shows a schematic of a typical sequence of a MALDI spot sample preparation.

FIG. 3 illustrates a schematic of the principle of performance monitoring and control in the context of the present disclosure.

FIG. 4 shows a schematic illustration of an ion spectrometry system with which the methods outlined in the present disclosure can be implemented.

### DETAILED DESCRIPTION

While the invention has been described and elucidated using a number of embodiments, experts in the field will recognize that various alterations can be undertaken in form and detail without departing from the scope of the technical teaching defined in the appended claims.

Using individual control sample measurements for performance monitoring and control of an ion source can lead to irritating results, since an individual control sample itself may be subject to error, for example as a result of failures during preparation. For MALDI preparation, a poorly crystallizing matrix substance is conceivable, for example if the ratio of matrix substance to molecule to be embedded (normally ~10 000-5000:1) does not meet specifications. Specifically in the field of clinical applications, for example the MALDI Biotyper® from Bruker, it may be the case that the analysis system is operated by a person trained only with the most necessary knowledge for operation thereof. For that reason, it is possible that this operator will be unable to recognize any incorrect preparations of individual control samples. As already mentioned in the introduction, regular verification by trained staff from the manufacturer or its service partner can provide a remedy, but only at high cost and with huge personnel input. Control sample preparations that do not meet requirements may also be caused by the age of the control sample substrate used itself or by poor quality of the reagents used for control sample preparation, for example if the user fails to notice or ignores expiry of use-by dates.

The aim is to allow the ion spectrometry system, after delivery to the user, to be optimized once by trained personnel, and the number of maintenance operations by trained personnel or the user that are required in the course of operation to be reduced or at least kept as low as possible. In this way, it is possible to reduce labour and costs. This aim, aside from other measures such as the ion source cleaning or detector voltage regulation mentioned at the outset, which are not the subject of this disclosure, but can serve merely as an add-on, can be achieved by (quasi-)automatic closed-loop control of an operating parameter of the laser for laser-assisted ionization.

A method of monitoring and controlling the performance of an ion source comprises the following steps: (a) laser-assisted ionization of a control sample, the composition of which is substantially known, and which, preferably in the same measurement operation, is sampled before, parallel to or after an analytical sample, (b) generating spectral control sample data from the ionized control sample in an ion analyser connected to the ion source, (c) repeating steps (a) and (b) over a multitude of control samples and optionally measurement operations in order to collect a multitude of spectral control sample data and evaluate them such that spectral data of individual control samples have low weight and a performance trend appears in the evaluation, (d) adjusting an operating parameter of the laser of the ion source if the performance trend enters a range outside a predefined performance interval, in order to bring the laser into interval conformance, and (e) repeating steps (a) through (d) for continuous monitoring and control of the ion source.

In step (a), the control sample may be sampled in an identical measurement operation to the analytical sample and, in step (c), steps (a) and (b) may be repeated over a multitude of measurement operations and control samples. A measurement operation in the context of the present disclosure may especially be considered to be that in relation to the mode of operation of the ion spectrometry system. For example, a measurement operation may comprise all measurements that are recorded from (control) samples on a sample carrier while it is spatially within the ion source. One example would be the introduction of the sample carrier into a reduced-pressure region of the ion source while it is working under reduced pressure, especially in the case of vacuum MALDI. If the sample carrier is removed from the ion source, for example the reduced-pressure region, and then a further sample carrier with new (control) samples is introduced again, all measurements on the new (control) samples on this next sample carrier may be regarded as a separate measuring operation.

As well as preparations of analytical samples, it is also possible for multiple control sample preparations to be disposed on a sample carrier for laser-assisted ionization. If there are both control samples and analytical samples on the sample carrier, e.g. 2-10 technical control sample replicates, especially 4-8 technical control sample replicates, all spectral control sample data for these preparations can be used to ascertain the performance trend and/or the progression thereof over time. A control sample preparation on the sample carrier can be sampled once or else more than once to generate spectral control sample data, limited in principle solely by the quantity of the control sample. As a result, the spectral control sample data may comprise individualized and separate spectra. Repeated sampling of the same control sample preparation increases the basis of the spectral control sample data for a subsequent statistical evaluation and reduces the effect of very short-term perturbations in particular in the measurement sequence that can cause outlier measurements.

What may be meant in particular by sampling of the control sample before, parallel to or after an analytical sample is that control sample and analytical sample are examined in the same measurement operation. The control sample may especially be sampled immediately before or immediately after an analytical sample. The measurement modes or measurement settings of the ion spectrometry system may be corresponding or else different for the sampling of analytical samples and control samples. If a measurement operation comprises the recording of spectral data of all (control) samples of a sample carrier, as set out above, this may mean that the sample carrier has a multitude of designated sample sites, for example a field of sample spots as on the known AnchorChip or MBT Biotarget 96 carriers from Bruker or else on a steel plate, and some of these sample sites are firstly prepared with a predetermined number of control samples, whereas some or all of the remaining sample sites are occupied by analytical samples. Control samples and analytical samples can then be sampled in blocks separately from one another (for example first all control samples, then all analytical samples) or else alternately (e.g. control sample⇒analytical sample⇒control sample⇒analytical sample etc.). In ion sources with multiple laser beams, it is optionally also possible to measure analytical samples and control samples in parallel from the same sample carrier if the connected ion analyser is designed and set up for the processing of multiplexed ion currents or when there is more than one ion analyser.

The ion analyser may be designed as a mass analyser that sorts the ionized control sample in particular by the principle of time-of-flight (TOF) dispersion. A mass analyser separates charged molecules or molecular ions according to their mass-to-charge ratio, typically referred to as m/z.

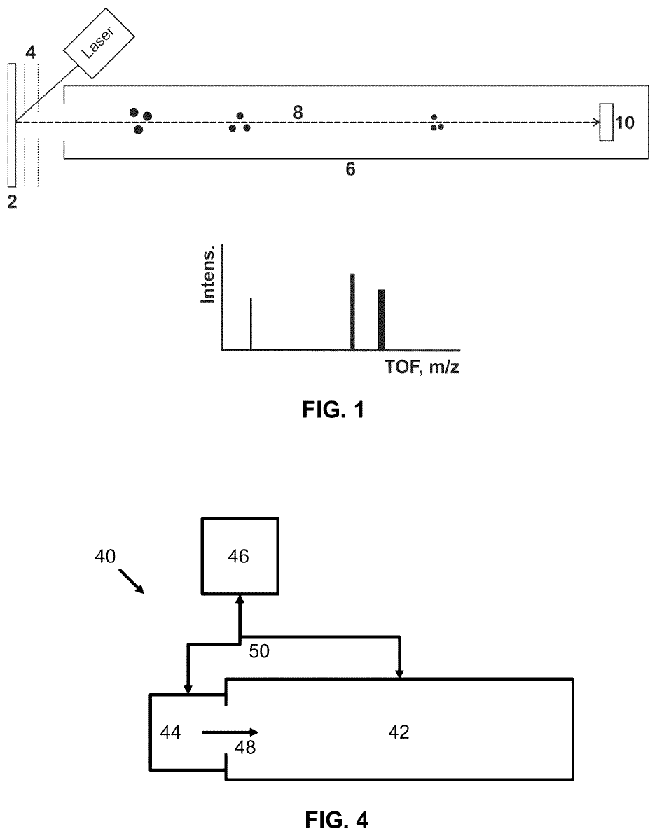

FIG. 1 shows a schematic of the principle of an axial-linear time-of-flight mass spectrometry system. Upper diagram: A laser bombards a (control) sample on the sample carrier 2, which has been prepared, for example, with a MALDI matrix substance. An assembly of electrodes 4 accelerates the ions formed in the laser bombardment, optionally after a delay time, into a flight tube 6 of the time-of-flight analyser along a straight trajectory 8. Since the different molecular species that form in the laser bombardment have different masses and bear a largely uniform charge, such that they are endowed with approximately the same kinetic energy in the acceleration, different speeds result. Light molecules, shown as small black circles, thus fly more quickly than heavy molecules, shown as circles of larger circumference, and hit the detector 10 earlier, which may take the form, for example, of a dynode array or of a multichannel plate (MCP). This time dependence of arrival at the detector permits assignment of charge-based masses m/z to the detection events; lower diagram.

As well as the time-of-flight analysers, for which both axial-linear constructions, as indicated in FIG. 1, and reflector constructions and/or those with orthogonal acceleration of ions onto the flight path (OTOF) may be provided, it is also possible in principle to use other types of mass-dispersing separators, e.g. quadrupole mass filters (single quads), triple quadrupole analysers (triple quads), ion cyclotron resonance (ICR) cells, Kingdon-type analysers such as the Orbitrap® (Thermo Fisher Scientific) and others. It is likewise conceivable to design the ion analyser as a mobility analyser or combined mobility/mass analyser, as already detailed above.

The control sample may comprise processing of a microorganism, for example a prokaryotic organism, especially processing of a bacteria species. Microorganism cells having an exactly known taxon and defined content of soluble molecules, e.g. ribosomal proteins and peptides, can be purchased commercially. Such a configuration in the case of standardized preparation can be expected to give a readily predictable and constant analyser and detector response with regard, for example, to mass signal profile or abundance. One example is the Bacterial Test Standard for the MALDI Biotyper® from Bruker, a MALDI axial-linear time-of-flight mass spectrometry system; the standard comprises a typical Escherichia coli DH5 alpha-peptide and protein profile, and additional proteins, suitable for uses including mass calibration.

The multitude of control samples is preferably congruent or identical; in particular, control samples that are congruent or identical are used over the multitude of measurement operations. In the case of microorganism preparation as a control sample, the measurements can be recorded over a long period of time from biological and/or technical replicates of the microorganism.

If the control sample comprises a microorganism, it has preferably been sterilized. The sterilizing may comprise exposure of the microorganism to a metabolism-inhibiting liquid, e.g. an alcohol such as ethanol or isopropanol or an acid such as formic acid, and/or to energy, for example with heat or high-energy radiation (optionally ultraviolet light). What is meant in particular by sterilizing is that the microorganism loses the ability to replicate even under conditions that are favourable to it. In this way, the biological risks attendant to unintended/uncontrolled spread can be avoided in an analysis laboratory. Under particular conditions, it may be dispensable to sterilize the microorganism in a control sample, for example when working in an analysis laboratory of biological safety level 2 or higher. It can be assumed in that case that sufficiently trained skilled personnel is being employed.

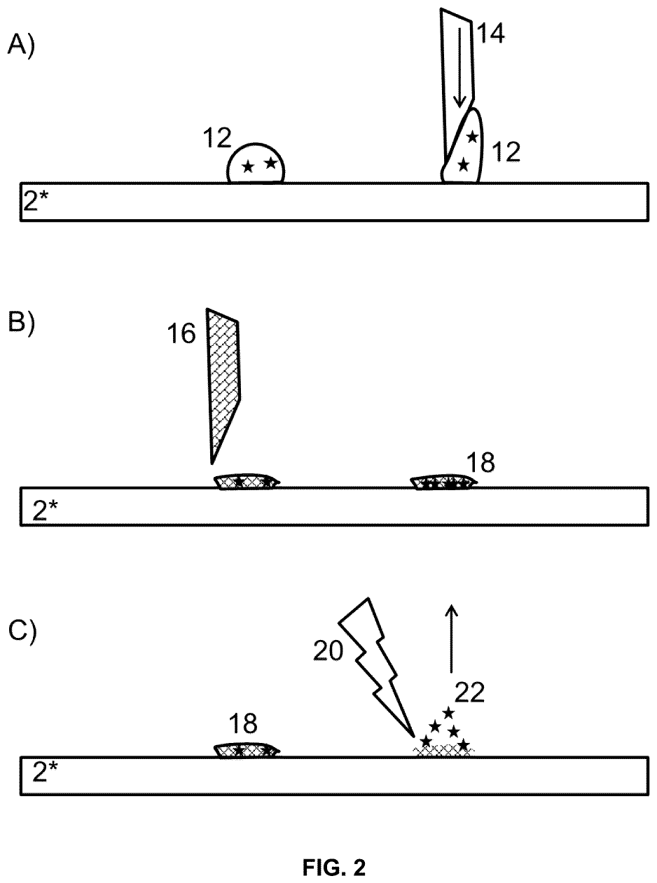

As set out above, the ion source may work by the MALDI principle. FIGS. 2A-C show a schematic of a MALDI process from the preparation of the (control) samples until the recording of spectral data. In FIG. 2A, (control) samples, for example a microorganism suspension 12 or a suspension containing soluble molecules extracted from a microorganism, is applied to the MALDI sample carrier 2* with a pipette 14 or another suitable dispensing device. The MALDI sample carrier used may, for example, be the AnchorChip or MBT Biotarget 96 carrier from Bruker or else steel plates. Once excess fluid in the suspension has been removed, a matrix substance solution can be applied to the fluid-depleted cell layer and/or layer of soluble molecules, for example by means of a suitable tool 16 such as a further pipette, illustrated here with tile-patterned hatching. After the matrix has been embedded, dried and crystallized, the individual (control) samples 18 are ready for sampling with a laser beam 20. The resultant ions 22 can then be accelerated, for example, onto the flight path of a time-of-flight analyser, as indicated schematically in FIG. 1.

The performance trend can be derived from an abundance or intensity of ions detected in the analyser; in particular, it is possible to use an average abundance or intensity. A measure of intensity or of abundance that can be used is, for example, the total amount of ion currents detected in the spectral data; this is occasionally called total ion count (TIC). The TIC can be detected over the entire spectral range or else over a limited sub-range, for example a range from the spectral data of 30 000 or more atomic mass units (amu), 20 000 or more amu, 10 000 or more amu, 5000 or more amu or 1000 amu or more. It is also possible to use an average intensity over the entire spectral range or a section thereof as a basis, for example a range from the spectral data of 30 000 or more atomic mass units (amu), 20 000 or more amu, 10 000 or more amu, 5000 or more amu or 1000 amu or more. A broad data basis assures statistical stability, i.e. low weight for outliers over several control samples, control sample samplings or measurement operations.

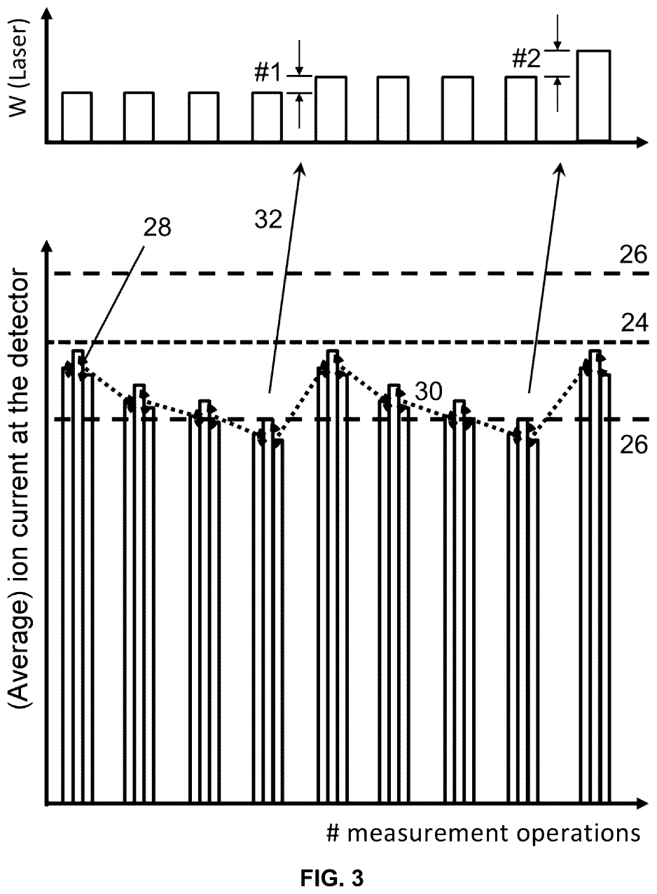

FIG. 3 is a schematic illustration of the feedback of monitoring of a performance trend over a prolonged period of time, recognition of a variance in a performance trend and resultant triggering of a change in an operating parameter of the laser for laser-assisted ionization. The lower diagram shows a time series of (average) ion current at the detector on the vertical axis over multiple measurement operations on the horizontal axis. A measurement operation may comprise ion spectrometry analysis of all (control) samples laid out on a sample carrier, for example provided that the sample carrier is disposed in a reduced-pressure region of the ion source. In the example shown, 9 sample carriers bearing control samples have accordingly been included in the evaluation. The number of control samples or control sample samplings per measurement operation that are evaluated for the performance trend is shown here schematically and illustratively as three, and represented in the diagram by three bars per measurement operation. It will be apparent that the number of control samples or control sample samplings per measurement operation may also differ therefrom. It is possible to sample 2-10 or 3-5 control samples, for example, per measurement operation, or to conduct a multiple thereof of control sample samplings, for example on a corresponding number of technical control sample replicates on the sample carrier. In the case of a sample carrier with designated spots for sample application, as in the case, for example, of the AnchorChip or MBT Biotarget 96, the number of control samples should be weighed against the number of analytical samples of unknown molecular content that the user would like to characterize via the ion spectrometry analysis. Given limited space on the sample carrier, it is alternatively possible to consider the applying and preparing of a plentiful individual control sample with elevated quality demands in the preparation, which is then subjected to a multitude of samplings to obtain a comprehensive spectral data basis for an individual measurement operation.

The middle horizontal dotted line 24 in the lower diagram indicates a guide ion current value that may represent an optimal setting found by extensive testing and calibration. In a typical MALDI time-of-flight mass spectrum, this ion current may correspond to an average intensity of 25 000-30 000 counts, especially 27 000 counts. The outer dotted lines 26 arranged around this middle line 24 represent the interval limits around the guide ion current value, within which the performance of the system composed of ion source and analyser can be described as meeting demands or as satisfactory. The performance interval may comprise variances up to a predefined percentage, especially ±30 per cent or less, ±25 per cent or less, ±20 per cent or less, ±15 per cent or less, or ±10 per cent or less. The boundary to higher ion currents may arise from avoidance of detector saturation, and the boundary to lower ion currents may be derived from experience as to how high an ion current signal has to be in order to permit a detectable and reliable evaluation of spectral data. The interval limits may be in an equidistant or else non-equidistant arrangement from the performance guide value. In one embodiment, an upper interval limit may lie closer to the performance guide value than a lower interval limit; in another embodiment, a lower interval limit may lie closer to the performance guide value than an upper interval limit.

The performance trend may also be derived from the quality of characterization of the molecular content of the substantially known control sample. If, for example, a microorganism is used as control sample, the highest similarity index [called log(score)] of the relevant spectral reference data of an ion spectrometry system designed for identification of the taxon, such as the MALDI Biotyper® from Bruker, may serve as performance guide value. Since the taxon of the microorganism in the control sample is substantially known, the log(score) of the MALDI Biotyper® should be well above 2.00. If the effect of the trend is that the log(score) is at and/or below the lower interval limit of 2.00 over a prolonged observation period and hence independently of outliers, it may be necessary to adjust an operating parameter of the laser in order to counteract this drop in performance.

The evaluation in step (c) may subject the multitude of spectral control sample data to averaging, especially mean or median averaging. The average formation may especially be based on the arithmetic average. FIG. 3 illustrates the ion current values averaged over three control samples or control sample samplings per measurement operation by means of dotted circles 28.

By the recording of spectral control sample data over a multitude of control samples, control sample samplings or measurement operations, it is possible to form a moving average; in other words, from a set of measurements, a subset that varies over time can be adduced, for example by taking account of spectral control sample data from a moving time window, optionally over a multitude of measurement operations, for average formation.

The averaging may be applied to a predetermined number of (i) control samples, e.g. 50-250 control samples, (ii) measurement operations, e.g. 10-30 measurement operations, (iii) laser activations, for example over 10⁵-10⁷ laser shots for single spectral data images, or (iv) a number of control samples or measurement operations from a predetermined period of time, for example over a period of 7-21 days, 1-4 weeks or 1-2 months. It is likewise possible to apply the averaging to a predetermined number of individualized control sample samplings, for example 400-2000 individualized control sample samplings. A common factor to all embodiments of the present disclosure is that the need for adjustment of the laser operating parameter is not made dependent on a single control sample and certainly not on an individual control sample sampling, but rather is based on a multitude of control samples and a multitude of control sample samplings.

FIG. 3 includes a trend line 30 that connects the different ion current averages, which permits an assessment as to how the observed ion current values for the control samples might evolve later on. In the specific example shown, it is found in the third measurement operation that the ion current average has attained the lower interval limit 26; for the fourth measurement operation, it is even found that the ion current average has left the interval range. The result of this finding is that an operating parameter of the laser is varied as a countermeasure, in order to counteract this drop in power; see arrow 32.

For the adjustment of the operating parameter, it is possible to alter laser energy density, laser fluence, laser power and/or laser intensity in the laser-assisted ionization, as apparent from the labelling of the vertical axis of the upper diagram in FIG. 3. In particular, laser energy density, laser fluence, laser power and/or laser intensity can be increased by a preset percentage if a variance in performance trend is recognized; see increment #1. An increase may be in the range of substantially single-digit percentage values, e.g. 1-10 per cent, especially about 1 per cent. The adjustment of the operating parameter of the laser may alternatively comprise a predefined increment, e.g. a particular percentage; it may also be calculated depending on the trend progression and/or absolute variance from the interval limit, for example with a fixed increment (optionally a percentage) as a basis, which is corrected by a trend-dependent term in order to avoid oversteer in the adjustment and to make an adjustment routine less dependent on outliers.

After the adjustment of the laser parameter between the fourth and fifth measurement operations as shown in the upper diagram of FIG. 3, the average ion current has again been re-stored to a range within the interval without any requirement for human intervention. The ion spectrometry system with ion analyser and ion source monitored and controlled in this way can then be operated further, and continues to give a measurement performance which meets demands or is satisfactory. If it should become apparent in the course of further measurement operations that the performance trend is again approaching an interval limit, as seen here by way of example in the 7th measurement operation, and then escapes from the interval range, as indicated in the 8th measurement operation, it is again possible to adjust the operating parameter of the laser (see adjustment #2), similarly to the manner elucidated above. Adjustment #2 may be identical to adjustment #1, or else may be executed with different adjustment increments.

A notification and/or marking may be generated if a number of adjustments of the operating parameter reaches or exceeds a predetermined value over time, e.g. 2-10 adjustments, especially 3-5 adjustments. The notification may take the form of an entry in the log file of the ion spectrometry system used. Also possible are notifications for the immediate attention of a user, for example a window that opens with a textual or pictorial message in the graphic user interface on the computer of the ion spectrometry system or an automatically generated email or SMS, the contents of which summarize the result of the spectral data evaluation. Such a textual/pictorial message, email or SMS can be transmitted directly by telecommunications to a recipient address of the ion spectrometry system manufacturer or a service partner, in order to automatically issue a maintenance request. A marking may especially include an entry into a comments field in the metadata for the spectral data that have been recorded under the altered laser conditions, in order to make it possible for the user to track the automated laser readjustment at a later juncture as well, for example in the evaluation of the spectral data for the analytical samples that have been detected alongside the spectral data for the control samples.

A composition of the analytical sample may be substantially unknown. Control sample and analytical sample differ in particular in that the control sample, its molecular content and its behaviour during laser-assisted ionization are very well known and characterized, which is the reason why it is used as controlled variable, whereas the information about the analytical sample first has to be ascertained by possibly elaborate post-processing. In the case of MALDI ionization, in the preparation of the analytical sample, only the matrix substance is well known; by contrast, molecular content and ionization behaviour of the analyte molecules have to be ascertained. The analytical sample may, for example, be a preparation assumed to contain a microorganism and/or extracted molecules, with the aim of determining the taxon of the microorganism down to the species and/or else resistance behaviour towards an antimicrobial substance. The analytical sample may also be a preparation containing cells, e.g. eukaryotic cells, the behaviour and/or re-action of which to exposure to a particular stimulus is to be examined, for example exposure to a toxicologically and/or pharmacologically active substance.

FIG. 4 shows a schematic of an ion spectrometry system 40 having an ion analyser 42, an ion source 44 connected to the ion analyser 42, and a processor unit 46 that communicates with the ion analyser 42 and the ion source 44 and is designed and programmed to execute a method as elucidated and described above, especially with reference to FIG. 3. The path of the ions from ion source 44 to the ion analyser 42 is symbolized by an arrow 48. The control and information reception communication of the processor unit 46 with the ion source 44 and the ion analyser 42 is indicated by double-headed arrows 50.

The invention is described above with regard to various particular working examples. However, it will be apparent that various features or details of the embodiments described can be altered without deviating from the scope of the invention. In addition, the features and measures disclosed in association with different embodiments may be combined as desired, if this seems practicable to a person skilled in the art. Moreover, the present description serves merely for illustration of the invention and not for restriction of the scope of protection, which is defined exclusively by the appended claims with regard to any existing equivalents.

1. A method of monitoring and controlling the performance of an ion source, comprising:
(a) ionizing a control sample, the composition of which is substantially known, with laser-assisted ionization of the ion source and which is sampled before, parallel to or after an analytical sample,
(b) generating spectral control sample data from the ionized control sample with an ion analyser connected to the ion source,
(c) repeating steps (a) and (b) for a plurality of control samples in order to collect a multitude set of spectral control sample data sufficient that, in an evaluation of said dataset, spectral data of individual control samples have low weight and a performance trend of the ion source is apparent from the evaluation,
(d) adjusting an operating parameter of a laser of the ion source if the performance trend enters a range outside a predefined performance interval, in order to bring the laser into interval conformance, and
(e) repeating steps (a) through (d) for continuous monitoring and control of the ion source.

2. The method according to claim 1 wherein, in step (a), the control sample is sampled in an identical measurement operation to the analytical sample and, in step (c), steps (a) and (b) are repeated over a plurality of measurement operations and control samples.

3. The method according to claim 1, wherein the ion analyser is a mass analyser that sorts the ionized control sample especially by the principle of time-of-flight dispersion.

4. The method according to claim 1, wherein the control sample comprises a microorganism.

5. The method according to claim 1, wherein the ion source works by the MALDI principle.

6. The method according to claim 1, wherein the performance trend is derived from an abundance or intensity of ions detected with the analyser.

7. The method according to claim 1, wherein the performance interval comprises variances up to a predefined percentage from a performance guide value.

8. The method according to claim 1, wherein the evaluation in step (c) subjects the set of spectral control sample data to averaging.

9. The method according to claim 8, wherein the averaging is applied to a predetermined number of (i) control samples, (ii) measurement operations, (iii) laser activations or (iv) control samples or measurement operations from a predetermined period of time.

10. The method according to claim 1 wherein, for adjustment of the operating parameter, laser energy density, laser fluence, laser power and/or laser intensity in the laser-assisted ionization is altered.

11. The method according to claim 1, further comprising generating a notification and/or marking when a number of adjustments of the operating parameter reaches or exceeds a predetermined value.

12. The method according to claim 1, wherein a composition of the analytical sample is substantially unknown.

13. An ion spectrometry system having an ion analyser, an ion source connected to the ion analyser, and a processor unit that communicates with the ion analyser and the ion source and is configured to coordinate and execute a method according to claim 1.

14. The method according to claim 4, wherein the microorganism is a bacteria species.

15. The method according to claim 8, wherein said averaging comprises mean or median averaging.
